(19) United States
(12) Patent Application Publication
(10) Pub. No.: US 2008/0286645 A1
(43) Pub. Date: Nov. 20, 2008

(54) ELECTROCHMICAL CELL ELECTRODE AND ELECTROCHEMICAL CELL

(75) Inventors: Tomoki NOBUTA, Sendai-shi (JP); Toshihiko NISHIYAMA, Sendai-shi (JP); Naoki TAKAHASHI, Sendai-shi (JP); Tetsuya YOSHINARI, Sendai-shi (JP)

Correspondence Address: KNOBBE MARTENS OLSON & BEAR LLP, 2040 MAIN STREET, FOURTEENTH FLOOR, IRVINE, CA, 92614, US

(73) Assignee: NEC TOKIN CORPORATION, Sendai-shi (JP)

(21) Appl. No.: 12/110,842

(22) Filed: Apr. 28, 2008

(30) Foreign Application Priority Data
May 17, 2007 (JP) 2007-131603

(51) Int. Cl. H01M 10/36; H01B 1/24; H01G 9/00

(52) U.S. Cl. 429/122; 252/500; 252/511; 361/500

(57) ABSTRACT

The present invention provides an electrode and an electrochemical cell which have a high capacity and are excellent in long term reliability. The present invention relates to a cell electrode comprising at least one organic compound polymer and a carbon material as a conductive auxiliary material wherein the included organic compound polymer is a compound causing an oxidation-reduction reaction based on the electrochemical proton adsorption and desorption and wherein the carbon material is heat treated at 500° C. or higher; and relates to an electrochemical cell using the same.

### BACKGROUND OF THE INVENTION

1. Field of the Invention

The present invention relates to an electrochemical cell electrode used in an electrochemical cell such as a secondary battery, an electric double layer capacitor, a redox capacitor and a condenser, and relates to an electrochemical cell.

2. Description of the Related Art

Secondary batteries, electric double layer capacitors, redox capacitors and condensers, which use as an electrode active material an organic compound polymer that causes an oxidation-reduction reaction on the basis of an electrochemical proton adsorption and desorption, have been proposed and put to practical use. The above-described devices are referred to as electrochemical cells.

Such an electrochemical cell is illustrated, for example, in a sectional view shown in FIG. 1. Specifically, as shown in FIG. 1, it has a configuration in which: a cathode electrode 2, including as an active material an organic compound polymer that causes an oxidation-reduction reaction on the basis of electrochemical proton adsorption and desorption, is formed on a cathode electrode current collector 1; an anode electrode 3, including as an active material an organic compound polymer that causes an oxidation-reduction reaction on the basis of electrochemical proton adsorption and desorption, is formed on an anode electrode current collector 4; and the electrodes are bonded to each other through a separator 5; wherein only protons are involved as charge carriers. Additionally, as an electrolyte, an aqueous or nonaqueous solution containing a proton source is filled in the cell and the cell is sealed with a gasket 6.

For the cathode electrode 2 and the anode electrode 3, used is a slurry which is prepared by adding a binder to a doped or undoped powder of the organic compound polymer and a conductive auxiliary material. Available as the method for forming the electrode are a method in which a solid electrode is formed by charging such the slurry in a mold having a desired size and by applying a heat press machine, and a method in which a film electrode is formed by screen printing the slurry on a conductive substrate and then drying the screen printed slurry. The cathode electrode 2 formed and the anode electrode 3 formed are disposed to face each other through the separator 5 so as to form the cell.

As the electrolyte, aqueous electrolytes composed of aqueous solutions of acids and nonaqueous electrolytes based on organic solvents are known. For proton conductive polymers, the former aqueous electrolytes are exclusively used because the aqueous electrolytes can provide high-capacity cells. Examples of such acids include organic and inorganic acids. Examples of acids used include: inorganic acids such as sulfuric acid, nitric acid, hydrochloric acid, phosphoric acid, tetrafluoroboric acid, hexafluorophosphoric acid and hexafluorosilicic acid; and organic acids such as saturated monocarboxylic acids, aliphatic carboxylic acids, oxycarboxylic acids, p-toluenesulfonic acid, polyvinylsulfonic acids and lauric acid.

As the conductive auxiliary materials for such electrochemical cells, Ketchen black has heretofore been used (see, for example, Japanese Patent Application Laid-Open Nos. 2005-209576 and 2006-32372). The electrode containing Ketchen black has advantages that a high conductivity is obtained by mixing an extremely small amount of Ketchen black because Ketchen black is much larger in specific surface area as compared to materials such as acetylene black and vapor grown carbon fiber (VGCF) and that a higher capacity is thereby achieved. However, the electrode has suffered a problem that gas is generated by energization to degrade the long term reliability.

Additionally, Japanese Patent Application Laid-Open No. 2005-129707 has proposed an electric double layer capacitor in which gas generation by energization is suppressed and which is excellent in long term reliability, and has disclosed an activated carbon which suitable for the electrodes of the electric double layer capacitor and a method for producing the same. Specifically, it relates to a method for producing an activated carbon for an electrode in an electric double layer capacitor comprising an activation step in which an alkali metal compound is mixed in an easily graphitizable carbon material and the mixture thus obtained is heated at temperatures higher than 600° C. and lower than 800° C. in an inert gas atmosphere to obtain the activated carbon.

### SUMMARY OF THE INVENTION

The present invention has been achieved in view of the above-described problem, namely, the degradation of the long term reliability found in a case where Ketchen black is used as a conductive auxiliary material for an electrochemical cell. Thus, the problem to be solved by the present invention is to provide an electrochemical cell electrode and an electrochemical cell which have a high capacity and are excellent in long term reliability.

For the purpose of solving the above described problem, the electrochemical cell electrode of the present invention comprises:

an organic compound polymer causing an oxidation-reduction reaction on the basis of an electrochemical proton adsorption and desorption; and

a carbon material, as a conductive auxiliary material, which is heat treated at 500° C. or higher and 950° C. or lower.

The carbon material preferably has a BET specific surface area of 800 m²/g or more and 3000 m²/g or less. The carbon material is preferably at least one selected from Ketchen black and activated carbons. The organic compound polymer may comprise at least one selected from indole compounds and quinoxaline compounds.

The electrochemical cell of the present invention comprises:

the above-mentioned electrochemical cell electrode; and

an electrolyte comprising a proton source;

wherein protons are involved as charge carriers associated with charge and discharge.

Further, the electrochemical cell of the present invention comprises:

an electrode comprising an activated carbon which is heat treated at 500° C. or higher and 950° C. or lower and which has a BET specific surface area of 800 m²/g or more and 3000 m²/g or lower; and

an electrolyte comprising a proton source;

wherein protons are involved as charge carriers associated with charge and discharge.

The gas generation in the course of an energization test is interpreted to be attributed to the functional groups which are present on the surface of carbon black or activated carbon. Specific examples of the functional groups include several types of surface functional groups such as a carboxyl group, a lactone group, a hydroxy group, a quinone group and a hydrogen atom. The electrode including such materials undergoes gas generation in the interior thereof during an energization test, and the generated gas increases the inner pressure in the interior of the electrochemical cell. Consequently, the resistance increase and the capacity decrease of the electrochemical cell are conceivably caused to degrade the long term reliability of the electrochemical cell. These surface functional groups can be removed by applying heat treatment based on heating. Consequently, gas generation can be prevented, and thus an electrochemical cell excellent in long term reliability can be obtained. In particular, effects to improve a high capacity and to improve a long term reliability are significant with Ketchen black and an activated carbon, each of which is a carbon material having a BET specific surface area of 800 m²/g or more and 3000 m²/g or less.

It is to be noted that in the activation step of the activated carbon in Patent Japanese Patent Application Laid-Open No. 2005-129707, the heating temperature is constrained to be higher than 600° C. and lower than 800° C. for the purpose of suppressing the evaporation of the alkali metal compound. Further, even when the heat treatment is applied after removal of the alkali metal, the heat treatment is constrained to be conducted at a temperature lower than the activation temperature for the purpose of maintaining the pores formed by the activation reaction. On the other hand, in the present invention, the heat treatment of the conductive auxiliary material or activated carbon can be conducted without any particular constraint except that the heat treatment temperature is equal to or lower than the decomposition temperature of the substance to be heat treated. Additionally, the technique disclosed in Japanese Patent Application Laid-Open No. 2005-129707 relates to a capacitor that takes advantage of the principle of the electric double layer as charge storage mechanism. However, the present invention relates to an electrochemical cell that takes advantage of the charge storage mechanism involving protons as charge carriers and is accompanied by oxidation-reduction reaction. Therefore, and the electrode configuration of the electrochemical cell and the configuration of the electrochemical cell are different from those of the above-described capacitor disclosed in Japanese Patent Application Laid-Open No. 2005-129707.

By applying a heat treatment to the conductive auxiliary material such as Ketchen black or an activated carbon included in the electrochemical cell electrode, and by thus removing the surface functional groups, there can be provided an electrochemical cell in which the internal resistance increase is suppressed and the capacity degradation is also suppressed and which is excellent in long term reliability.

### BRIEF DESCRIPTION OF THE DRAWINGS

FIG. 1 is a sectional view of a fundamental element of an electrochemical cell;

FIG. 2 is a sectional view of a terminal-equipped electrochemical cell; and

FIG. 3 is a sectional view of a button-shaped electrochemical cell.

### DETAILED DESCRIPTION OF THE PREFERRED EMBODIMENT

Hereinafter, the embodiment of the present invention is described with reference to the accompanying drawings.

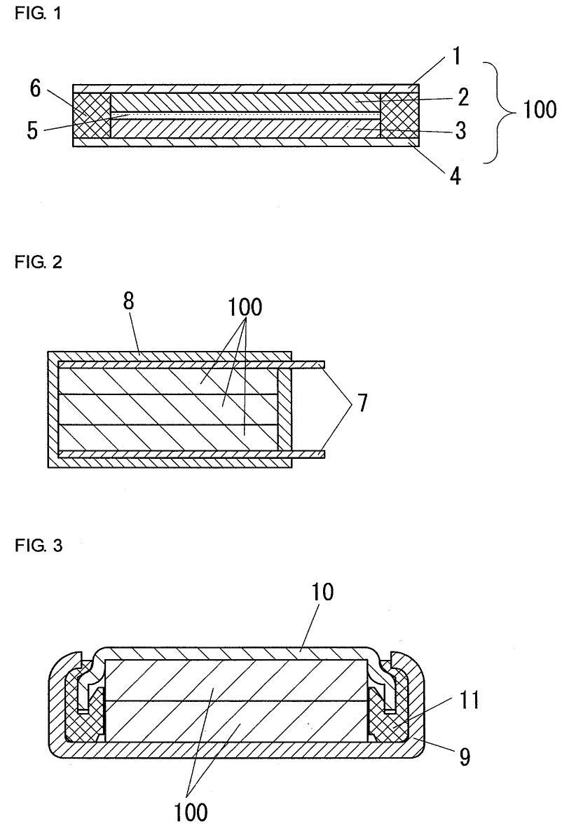

FIG. 1 is a sectional view of a fundamental element of an electrochemical cell. By taking as an example a proton conducting polymer battery as an electrochemical cell, the configuration and the preparation method of the electrochemical cell are described. The fundamental element of the proton conducting polymer battery has a configuration in which: a cathode electrode 2 is formed on a cathode electrode current collector 1; a anode electrode 3 is formed on a anode electrode current collector 4; and these electrodes are bonded to each other through a separator 5; wherein only protons are involved as charge carriers. Additionally, as an electrolyte, an aqueous or nonaqueous solution containing a proton source is filled in the cell and the cell is sealed with a gasket 6 to prepare the fundamental element 100.

FIG. 2 is a sectional view of a terminal-equipped electrochemical cell, and FIG. 3 is a sectional view of a button-shaped electrochemical cell. The terminal-equipped electrochemical cell has a structure: in which an arbitrary number of fundamental elements 100 are stacked; and thereafter, as shown in FIG. 2, metal lead terminals 7 are disposed respectively on the cathode electrode and the anode side, and the fundamental elements and the terminals are enclosed in an external packaging case 8 except for the externally accessible portions of the lead terminals 7. The button-shaped electrochemical cell has a structure in which: an arbitrary number of fundamental elements 100 are stacked; and thereafter, as shown in FIG. 3, the fundamental elements are enclosed with a case 9 and a cap 10 through a packing 1 1.

The cathode electrode 2 and the anode electrode 3 as the electrochemical cell electrodes of the present invention are prepared as follows. Specifically, Ketchen black (manufactured by Ketchen Black International Co.) or activated carbon as a conductive auxiliary material are mixed with an organic compound polymer as an active material in an amount of 1 to 50 parts by mass, preferably 5 to 30 parts by mass relative to the active material. This mixed powder or activated carbon is dispersed in an arbitrary organic solvent or aqueous solvent to prepare a slurry. Optionally, a binder is mixed in the slurry in an amount of 1 to 20 parts by mass, preferably 2 to 10 parts by mass relative to the active material. The slurry is screen printed on a conductive substrate and dried to prepare the electrodes.

The organic compound polymer included in the electrode of the present invention is not particularly limited, as long as the organic compound polymer is a compound and/or an activated carbon, etc., which has oxidation-reduction property in a solution containing a proton source.

Examples of such compounds include: πconjugated polymers such as polyaniline, polythiophene, polypyrrole, polyacetylene, poly-p-phenylene, polyphenylenevinylene, polyperinaphthalene, polyfuran, polythienylene, polypyridinediyl, polyisothianaphthene, polyquinoxaline, polypyridine, polypyrimidine, polyindole, indole compounds such as indole trimer, polyaminoanthraquinone, polyimidazole and the derivatives of these polymers; hydroxyl group-containing polymers (transformed from quinone oxygen atoms into hydroxyl groups by conjugation) such as polyanthraquinone and polybenzoquinone; and conductive polymers obtained by copolymerization of two or more kinds of monomers. By applying doping to these polymers, redox pairs are formed to exhibit conductivity. These compounds are selected to be used as the cathode electrode active materials and anode electrode active materials through appropriate regulation of the oxidation-reduction potential difference.

As the conductive auxiliary material, the following carbon materials can be appropriately used: carbon blacks such as acetylene black and Ketchen black, vapor grown carbon VGCF, and activated carbons. Among these carbon materials which have a BET specific surface area of 800 m²/g or more and 3000 m²/g or less are preferable because even small amounts of such materials provide a high conductivity electrode. Specifically, Ketchen black and activated carbons are preferable.

The binder is not particularly limited; however, PVdF and PTFE are preferable.

The surface functional groups of these generally commercially available conductive auxiliary materials are known to vanish in such a way that with a boundary in the vicinity of 400 to 500° C., oxygen-containing groups such as carboxyl groups, hydroxy groups and quinone groups vanish on the lower temperature side, and hydrogen-containing groups such as hydrogen vanish on the higher temperature side. Therefore, the temperature of the heat treatment by heating is only required to be equal to or lower than the decomposition temperature of the substance to be heat treated; however, the peak temperature is preferably 950° C. or lower, and particularly preferably 500° C. or higher and 950° C. or lower. The peak temperature may also be 600° C. or lower. The peak temperature may also be 800° C. or higher. The time for treatment is arbitrary, but is preferably approximately 0.5 to 2 hours from the viewpoint of workability. The atmosphere for treatment may be any of air atmosphere and an inert gas atmosphere. In the present invention, it is not necessary to mix an alkali metal compound to the conductive auxiliary material for the heat treatment.

As the electrolyte, an aqueous or nonaqueous solution containing a proton source is used. For example, acids such as organic and inorganic acids can be used. Examples of acids include inorganic acids such as sulfuric acid, nitric acid, hydrochloric acid, phosphoric acid, tetrafluoroboric acid, hexafluorophosphoric acid and hexafluorosilicic acid; and organic acids such as saturated monocarboxylic acids, aliphatic carboxylic acids, oxycarboxylic acids, p-toluenesulfonic acid, polyvinylsulfonic acids and lauric acid. The proton content is preferably 10⁻³ mol/l to 18 mol/l, and more preferably 10⁻¹ mol/l to 7 mol/l.

The separator can be used without imposing any particular constraint as long as the separator can electrically insulate between the cathode electrode and the anode electrode in the electrochemical cell. Examples of the separator include polyolefin porous films and ion-exchange films. The thickness of the separator is not particularly limited, but is preferably 10 to 200 μm and more preferably 10 to 80 μm.

The possible external packaging shape of the electrochemical cell includes a coin shape and a laminate shape without any particular constraint imposed thereon. Additionally, the electrochemical cell of the present invention preferably includes an electrolyte which contains a proton source and which can be preferably operated so as to involve protons as the charge carriers associated with charge and discharge.

### EXAMPLES

Hereinafter, the present invention is more specifically described on the basis of examples, but the present invention is not limited these examples.

### Example 1

A cathode electrode was prepared as follows. Methyl indole-6-carboxylate trimer represented by the chemical formula (1) was used as a cathode electrode active material; Ketchen black EC600JD with a BET specific surface area of 1270 m²/g which had been heat treated with a peak temperature of 950° C. (with a temperature increase time of 1 hour and a temperature maintaining time of 1 hour) was used as a conductive auxiliary material; these materials were mixed in a weight ratio of 95:5 to prepare a slurry; and thereby the cathode electrode was formed on a current collector. An anode electrode was formed by using polyphenylquinoxaline represented by the chemical formula (2) and in the otherwise same manner as in the cathode electrode.

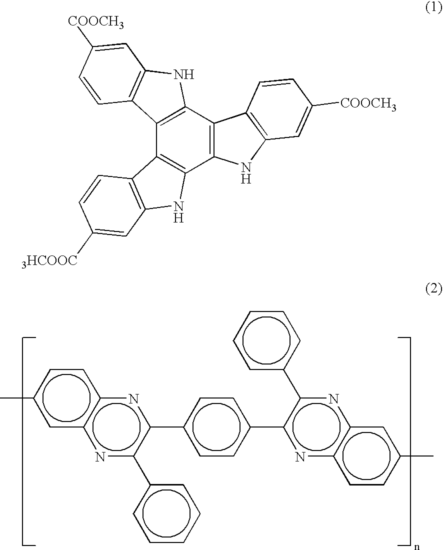

20 wt % sulfuric acid aqueous solution was used as the electrolyte, and a porous nonwoven fabric with a thickness of 50 μm was used as the separator. The cathode electrode and the anode electrode were bonded to each other through this separator so as for the electrode surfaces of the cathode and anode electrodes to face each other. The assembly thus obtained was externally packaged with a gasket to prepare an electrochemical element; then, prepared was an electrochemical cell in which five of the electrochemical elements were electrically stacked in series.

### Example 2

An electrochemical cell was prepared in the same manner as in Example 1 except that the peak temperature of the heat treatment of Ketchen black EC600JD used for the cathode electrode was set at 850° C.

### Example 3

An electrochemical cell was prepared in the same manner as in Example 1 except that the peak temperature of the heat treatment of Ketchen black EC600JD used for the cathode electrode was set at 500° C.

### Comparative Example 1

An electrochemical cell was prepared in the same manner as in Example 1 except that Ketchen black EC600JD used for the cathode electrode was used without applying any heat treatment.

### Comparative Example 2

An electrochemical cell was prepared in the same manner as in Example 1 except that VGCF which has a BET specific surface area of 13 m²/g was used as a conductive auxiliary material for the cathode electrode.

The electrochemical cells prepared in Examples 1 to 3 and Comparative Examples 1 and 2 were subjected to an energization test at 70° C. at 5.5 V. The capacities after energization for 500 hour were measured and the residual capacity ratios relative to the initial capacity was calculated. The initial capacities were calculated as the ratios relative to the initial capacity of Comparative Example 1 in which no heat treatment was applied to the conductive auxiliary material. The capacity measurements were carried out in the voltage range from 5.5 V to 0 V. The results are shown in Table 1.

TABLE 1

| | BET specific | | | |
|---|---|---|---|---|
| | surface | | | |
| | area of | Peak temperature | Initial | |
| | conductive | of heat treatment | capacity | Residual |
| | auxiliary | for conductive | relative to | capacity ratio |
| | material | auxiliary material | Comp. Ex. 1 | after 500 hours |
| Level | (m²/g) | (° C.) | (%) | (%) |
| Ex. 1 | 1270 | 950 | 99 | 93.4 |
| Ex. 2 | | 850 | 103 | 78.9 |
| Ex. 3 | | 500 | 105 | 69.0 |
| Comp. | | No | 100 | 51.2 |
| Ex. 1 | | heat treatment | | |
| Comp. | 13 | | 68 | 94.1 |
| Ex. 2 | | | | |

The initial capacity relative to Comparative Example 1 was found to be 99% in Example 1, 103% in Example 2, 105% in Example 3, and 68% in Comparative Example 2. The residual capacity ratio after 500 hours was found to be 93.4% in Example 1, 78.9% in Example 2, 69.0% in Example 3, 51.2% in Comparative Example 1, and 94.1% in Comparative Example 2.

### Example 4

Electrodes as the cathode and anode electrodes were formed by using an activated carbon derived from a phenolic resin, which had a BET specific surface area of 850 m²/g and which was heat treated with a peak temperature of 600° C. (with a temperature increase time of 1 hour and a temperature maintaining time of 1 hour). Here, no additional conductive auxiliary material was added and mixed, so that the composition of each of the electrodes was such that the activated carbon accounted for 100%. 40 wt % sulfuric acid solution was used as the electrolyte. An electrochemical cell was prepared in the same manner as in Example 1.

### Example 5

An electrochemical cell was prepared in the same manner as in Example 4 except that the activated carbon was heat treated with a peak temperature of 950° C.

### Comparative Example 3

An electrochemical cell was prepared in the same manner as in Example 4 except that the activated carbon was used for the electrodes without applying any heat treatment.

The electrochemical cells prepared in Examples 4 and 5 and Comparative Example 3 were subjected to a cycle test at 70° C. at a charging voltage of 6.0 V. The test conditions were such that charging was conducted at CC (constant current) (10 C)−CV (constant voltage) (6 V) for 10 minutes and discharging was conducted at CC (10 C) to 0 V. This charge-discharge cycle was repeated 300 times, and then the residual capacity ratio relative to the initial value and the variation factor of the equivalent series resistance (ESR) at 1 kHz were calculated. The initial capacities were calculated as the ratios relative to the discharge capacity of Comparative Example 1 in which no heat treatment was applied. The results thus obtained are shown in Table 2.

TABLE 2

| | Initial capacity | | |
|---|---|---|---|
| | relative to | After 300 cycles | |
| | Comp. Ex. 3 | Residual capacity ratio | ESR |
| Level | (%) | (%) | (variation factor) |
| Ex. 4 | 100 | 91.1 | 1.12 |
| Ex. 5 | 108 | 88.7 | 1.03 |
| Comp. | 100 | 76.4 | 1.76 |
| Ex. 3 | | | |

The initial capacity relative to Comparative Example 3 was found to be 100% in Example 4, and 108% in Example 5. The residual capacity ratio after 300 cycles was found to be 91.1% in Example 4, 88.7% in Example 5, and 76.4% in Comparative Example 3. The variation factor of the ESR was found to be 1.12 in Example 4, 1.03 in Example 5, and 1.76 in Comparative Example 3.

Examples 1, 2 and 3 provided results for properties such that the long term reliability was excellent while a high capacity was being maintained. Additionally, as the heat treatment temperature was increased, satisfactory tendencies of properties were found. As described above, since there are differences between the decomposition temperatures of the surface functional groups, the satisfactory tendencies may be ascribed to the reflection of the effects of such differences on the performance.

In Comparative Example 2, there were obtained properties excellent in reliability without applying any heat treatment when the specific surface area of the used conductive auxiliary material was small; however, there remains a problem that the initial capacity is small. For example, the capacity after 500 hours is smaller as compared to those in Examples, and it can hardly be said that the object of the present invention was able to be achieved.

As can be seen from Examples 4 and 5, the electrochemical cells using the activated carbon having been heat treated exhibited the same tendencies as those in Examples 1 to 3, underwent suppression of the resistance increase, and maintained satisfactory cycle properties such that the residual capacity rates were 80% or more.

What is claimed is:

1. An electrochemical cell electrode comprising:
an organic compound polymer causing an oxidation-reduction reaction on the basis of an electrochemical proton adsorption and desorption; and
a carbon material, as a conductive auxiliary material, which is heat treated at 500° C. or higher and 950° C. or lower.

2. The electrochemical cell electrode according to claim 1, wherein the carbon material has a BET specific surface area of 800 m²/g or more and 3000 m²/g or less.

3. The electrochemical cell electrode according to claim 1, wherein the carbon material is at least one selected from Ketchen black and activated carbons.

4. The electrochemical cell electrode according to claim 2, wherein the carbon material is at least one selected from Ketchen black and activated carbons.

5. The electrochemical cell electrode according to claim 1, wherein the organic compound polymer comprises at least one selected from indole compounds and quinoxaline compounds.

6. The electrochemical cell electrode according to claim 2, wherein the organic compound polymer comprises at least one selected from indole compounds and quinoxaline compounds.

7. The electrochemical cell electrode according to claim 3, wherein the organic compound polymer comprises at least one selected from indole compounds and quinoxaline compounds.

8. The electrochemical cell electrode according to claim 4, wherein the organic compound polymer comprises at least one selected from indole compounds and quinoxaline compounds.

9. An electrochemical cell comprising:
the electrochemical cell electrode according to claim 1; and
an electrolyte comprising a proton source;
wherein protons are involved as charge carriers associated with charge and discharge.

10. An electrochemical cell comprising:
the electrochemical cell electrode according to claim 2; and
an electrolyte comprising a proton source;
wherein protons are involved as charge carriers associated with charge and discharge.

11. An electrochemical cell comprising:
the electrochemical cell electrode according to claim 3; and
an electrolyte comprising a proton source;
wherein protons are involved as charge carriers associated with charge and discharge.

12. An electrochemical cell comprising:
the electrochemical cell electrode according to claim 4; and
an electrolyte comprising a proton source;
wherein protons are involved as charge carriers associated with charge and discharge.

13. An electrochemical cell comprising:
the electrochemical cell electrode according to claim 5; and
an electrolyte comprising a proton source;
wherein protons are involved as charge carriers associated with charge and discharge.

14. An electrochemical cell comprising:
the electrochemical cell electrode according to claim 6; and
an electrolyte comprising a proton source;
wherein protons are involved as charge carriers associated with charge and discharge.

15. An electrochemical cell comprising:
the electrochemical cell electrode according to claim 7; and
an electrolyte comprising a proton source;
wherein protons are involved as charge carriers associated with charge and discharge.

16. An electrochemical cell comprising:
the electrochemical cell electrode according to claim 8; and
an electrolyte comprising a proton source;
wherein protons are involved as charge carriers associated with charge and discharge.

17. An electrochemical cell comprising:
an electrode comprising an activated carbon which is heat treated at 500° C. or higher and 950° C. or lower and which has a BET specific surface area of 800 m²/g or more and 3000 m²/g or lower; and
an electrolyte comprising a proton source;
wherein protons are involved as charge carriers associated with charge and discharge.
